(19) United States
(12) Patent Application Publication
(10) Pub. No.: US 2004/0137778 A1
(43) Pub. Date: Jul. 15, 2004

(54) Electrical connector with a locking ring, especially a coaxial plug

(76) Inventors: Kristof Mattheeuws, Knesselare (BE); Reginald Leeman, Oostende (BE)

Correspondence Address: Barley, Snyder, Senft & Cohen, LLC, 126 East King Street, Lancaster, PA, 17602-2893, US

(21) Appl. No.: 10/689,938

(22) Filed: Oct. 21, 2003

(30) Foreign Application Priority Data
Oct. 22, 2002 (EP) 02 023 505.7

(51) Int. Cl. H01R 13/627

(52) U.S. Cl. 439/352

(57) ABSTRACT

An electrical connector has a first connector member, a second connector member, and a locking ring. The first connector member has a first contact and an abutment surface. The second connector member has a second contact for electrical connection with the first contact and a groove. The locking ring is disposed on the first connector member and has latching fingers. The latching fingers are of at least a first type and a second type. The first type has a different length than the second type so that the first type engages the groove when the abutment surface is a first distance from the groove and the second type engages the groove when the abutment surface is a second distance from the groove when the first and second connector members are mated to lock the first connector member to the second connector member.

### FIELD OF THE INVENTION

The invention relates to an electrical connector with a first connector member that is mated with a second connector member and secured thereto with a locking ring.

### BACKGROUND OF THE INVENTION

Axially mating electrical connectors include a first connector member that is mated with a second connector member. The first connector member has an axial bore and a first contact. The second connector member has a second contact and a cylindrical body that is received in the axial bore. The first and second contacts are electrically connected when the first connector member and the second connector member are mated. Either the cylindrical body or the axial bore includes a groove. A locking ring is arranged between the cylindrical body and the axial bore. The locking ring has latching fingers that engage with the groove so that the first and second connector members are prevented from disengaging. One example of such an axially mating electrical connector with a locking ring is disclosed in DE 197 49 130.

In order to ensure that the locking ring locks the first connector member to the second connector member, the fingers have to be a specific length and have to be positioned at a specific angle. Specifically, to guarantee an axial locking with a very small clearance, it is necessary that a diameter of the axial bore and a diameter of the cylindrical body and the length and the angle of the fingers are within a small range of values. This causes high production costs.

### SUMMARY OF THE INVENTION

It is an object of the invention is to provide an electrical connector that reduces an axial movement of a first and second connector member, even in a case of high production tolerances.

This and other objects are achieved by an electrical connector having a first connector member, a second connector member, and a locking ring. The first connector member has a first contact. The second connector member has a groove and a second contact for electrical connection with the first contact. The locking ring is disposed on the first connector member. The locking ring has latching fingers that engage the groove when the first connector member and the second connector member are mated to lock the first connector member to the second connector member. The latching fingers are of at least a first type and a second type. The first type has a different length than the second type.

This and other objects are further achieved by an electrical connector having a first connector member, a second connector member, and a locking ring. The first connector member has a first contact. The second connector member has a groove and a second contact for electrical connection with the first contact. The locking ring is disposed on the first connector member. The locking ring has latching fingers that engage the groove when the first connector member and the second connector member are mated to lock the first connector member to the second connector member. The latching fingers are of at least a first type and a second type. The first type is formed at a different angle with respect to a plane of the locking ring than the second type.

This and other objects are still further achieved by an electrical connector having a first connector member, a second connector member, and a locking ring. The first connector member has a first contact and an abutment surface. The second connector member has a second contact for electrical connection with the first contact and a groove. The locking ring is disposed on the first connector member and has latching fingers. The latching fingers are of at least a first type and a second type. The first type has a different length than the second type so that the first type engages the groove when the abutment surface is a first distance from the groove and the second type engages the groove when the abutment surface is a second distance from the groove when the first and second connector members are mated to lock the first connector member to the second connector member.

### BRIEF DESCRIPTION OF THE DRAWINGS

FIG. 1 is a partial longitudinal sectional view of a connector system according to the invention showing first and second connector members in a mated position;

FIG. 2 is a sectional view of the first connector member;

FIG. 3 is an enlarged sectional view of an inner sleeve and latching fingers;

FIG. 4 is a sectional view of an unlocking sleeve of the first connector member;

FIG. 5 is a partial longitudinal sectional view of the second connector member;

FIG. 6 is a perspective view of a locking ring;

FIG. 7 is a top view of the locking ring of FIG. 6;

FIG. 8 is a sectional view of the locking ring of FIG. 6;

FIG. 9 is a schematic diagram of a mated position of the first and second connector members showing a first distance between a groove and an abutment surface;

FIG. 10 is a schematic diagram of a mated position of the first and second connector members showing a second distance between a groove and an abutment surface; and

FIG. 11 is a schematic diagram of a mated position of the first and second connector members showing a third distance between a groove and an abutment surface.

### DETAILED DESCRIPTION OF THE INVENTION

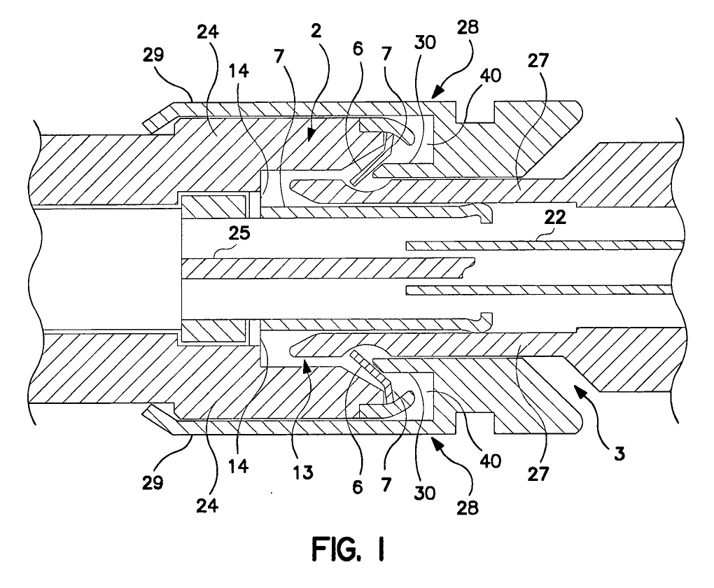

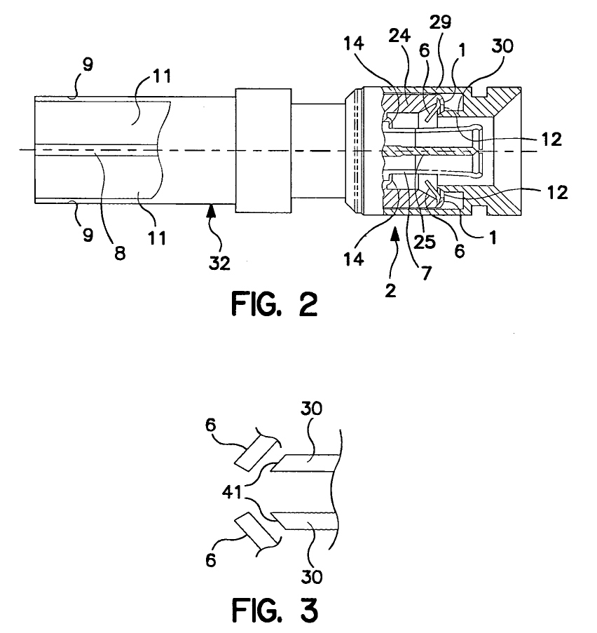

FIG. 1 shows a connector system with a first connector member 2, a second connector member 3, and a locking ring 1. As shown in FIGS. 1 and 2, the first connector member 2 has a sleeve body 24. The sleeve body 24 has an opening 13 arranged with a first sleeve 7. The first sleeve 7 has a circular cross-section. A contacting pin 25 is arranged in a center of the first sleeve 7. The first sleeve 7 and the contacting pin 25 are electrically isolated and can be used for conducting different potentials. For example, the first sleeve 7 may be used as a shielding for signals of the contacting pin 25. The sleeve body 24 includes a stop sleeve made of metal that has a bent rim 12 at a front end thereof. The bent rim 12 is bent on an inside in a direction of the first sleeve 7. The locking ring 1 is arranged between a front end of the sleeve body 24 and the bent rim 12. The distance between the front end of the sleeve body 24 and the rim 12 may be greater than a height of the locking ring 1 to provide some clearance for the locking ring 1 in an axial direction. The first connector member 2 has an abutment surface 14. The abutment surface 14 may be, for example, a rim of a stop sleeve, a bended rim of a stop sleeve, or a rim of a spring that is fixed to the sleeve body 24.

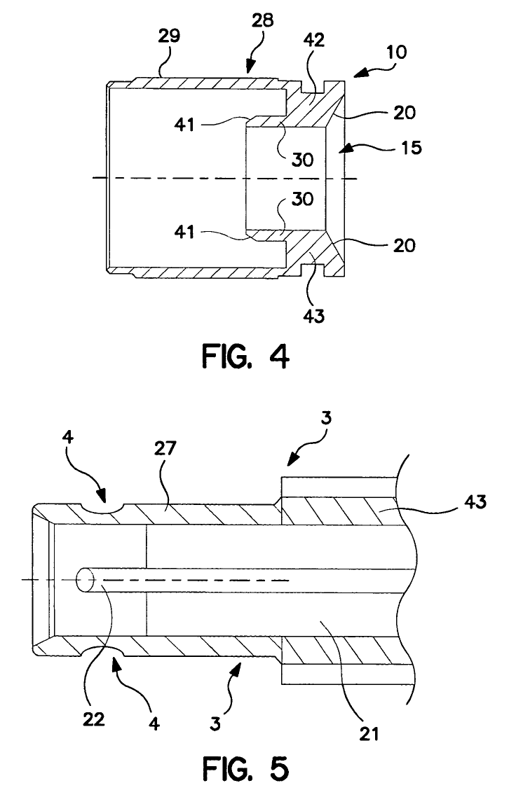

As shown in FIG. 1, an unlocking member 28 surrounds the sleeve body 24 and is formed to slide along a longitudinal axis of the sleeve body 24. As shown in FIG. 4, the unlocking member 28 has an outer sleeve 29 and an inner sleeve 30 arranged parallel to the outer sleeve 29. The inner sleeve 30 has a central opening 15 and an annular flange 41 that is inclined from an outer side to an inner side in a direction of latching fingers 6 arranged on the locking ring 1. The annular flange 41 is formed to support latching fingers 6 on the locking ring 1 that are being pushed outwards when the outer sleeve 29 is moved on the sleeve body 24. The inner and the outer sleeves 30, 29 are connected by a ring part 42 arranged at a front of the unlocking member 28. The ring part 42 includes a conical flange 20 at a front side that is inclined towards the central opening 15. The inner sleeve 30 has a cylindrical opening for receiving a second sleeve 27 of the second connector member 3, when the second connector member 3 is mated with the first connector member 2. The inner sleeve 30 has a diameter smaller than a diameter of the locking ring 1 but greater than a distance between two opposite latching fingers 6. The inner sleeve 30 is arranged in a mated position in front of the latching fingers 6. An annular receiving chamber 40 is positioned between the inner and outer sleeves 30, 29 and is open in a direction of the sleeve body 24. The receiving chamber 40 receives a front part of the sleeve body 24.

As shown in FIG. 5, the second sleeve 27 of the second connector member 3 is electrically isolated from a contacting sleeve 22. The second sleeve 27 is formed such that when the first sleeve 7 is inserted into the second sleeve 27, the first sleeve 7 is electrically connected with the second sleeve 27, and an ending of the second sleeve 27 is positioned adjacent to the abutment surface 14 of the first connector member 2. A second annular insulator 21 surrounds the contacting sleeve 22. A second outer conductor 43 that is electrically connected with the second sleeve 27 surrounds the second annular insulator 21. Arranged at a predetermined distance from a front end of the second sleeve 27 and on an outer surface of the second sleeve 27 is an annular groove 4.

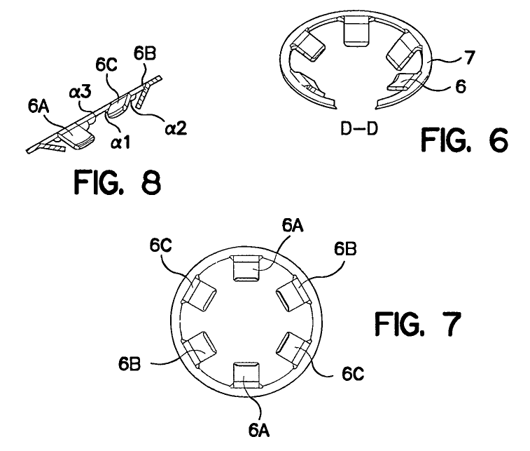

As shown in FIGS. 6-8, the locking ring 1 has a plurality of the latching fingers 6 arranged on an inner side of the locking ring 1 and directed toward a lower side of a plane of the locking ring. As shown in FIG. 7, the locking ring 1 is provided with first, second and third types 6A, 6B, 6C, respectively, of latching fingers 6. Each of the types 6A, 6B, 6C has latching fingers 6 with a different length. The first type 6A of latching fingers 6 are of the greatest length, the second type 6B of latching fingers 6 are of a middle length, and the third type 6C of latching fingers 6 are of the smallest length. As shown in FIG. 6, two fingers of the same type are preferably arranged at opposite sides of the locking ring 1. The invention, however, is not limited to the three types 6A, 6B, 6C of latching fingers 6. The locking ring 1 may be provided with more types or fewer types of the latching fingers 6. The difference in the length between the first, second, and third types 6A, 6B, 6C of latching fingers 6 is greater than the different lengths that occur due to production variances in latching fingers of the same type where the range of the length only varies up to three percent of the length.

The first, second, and third types 6A, 6B, 6C of latching fingers 6 are arranged at different angles with respect to the plane. The first type 6A of latching fingers 6 is inclined at a first angle α1, the second type 6B of latching fingers 6 is inclined at a second angle α2, and the third type of latching fingers 6 is inclined at a third angle α3 compared to the plane of the ring 1. The first angle α1 is greater than the second angle α2 and the second angle α2 is greater than the third angle α3. Alternatively, in a simple embodiment all of the latching fingers 6 could be arranged at the same angle.

As shown in FIG. 2, the first connector member 2 is connected to a cable 32. The cable 32 includes a central conductor 8 that is connected with the contacting pin 25. An annular dielectric insulator 11 surrounds the central conductor 8. An outer conductor 9 surrounds the dielectric insulator 11. The outer conductor 9 is electrically connected with the first sleeve 7. In the illustrated embodiment, the first connector member 2 is a coaxial connector plug and the second connector member 3 is a coaxial jack, however, the invention is not limited to this embodiments and may be adapted for use with other kinds of connector members.

The mating of the first connecting member 2 with the second connecting member 3 will now be described. The contacting pin 25 of the first connector member 2 is inserted into the contacting sleeve 22 of the second connector member 3 to electrically connect the contacting pin 25 and the contacting sleeve 22. The sleeve body 24 locks the locking ring 1, and the latching fingers 6 engage with the groove 4 when the first and second connecting members 2, 3 are mated. The latching fingers 6 hold the second connector member 3 and the second sleeve 27 against the abutment surface 14. If the second connector member 3 is attempted to be unmated from the first connector member 2, the groove 4 is pushed against the latching fingers 6, which are stiff, to retain the locking ring 1. The latching fingers 6 thereby prevent the second connector member 3 from being drawn-off the first connector member 2.

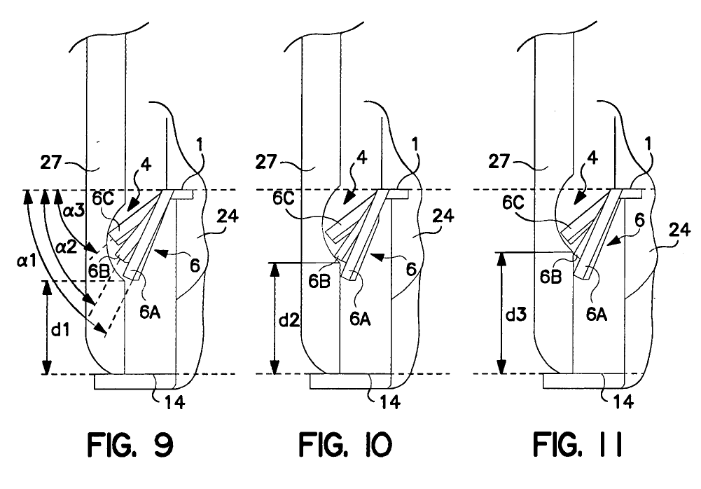

FIGS. 9-11 show different embodiments of first and second connector members wherein in each embodiment the distance between the abutment surface 14 of the first connector member 2 and the groove 4 of the second connector member 3 varies due to high production ranges. Because the distance between the abutment surface 14 of the first connector member 2 and the groove 4 of the second connector member 3 varies, the distance between the groove 4 and the locking ring 1 also varies. To compensate for these different distances, the locking ring 1 is provided with different types of the latching fingers 6 to ensure the second connector member 3 is held against the first connector member 2. As a result, the impedance of the connection between the first and second connector members 2, 3 is the same, although the position of the groove 4 varies.

As shown in FIG. 9, the groove 4 is arranged at a first distance d1 from the abutment surface 14 causing the distance between the groove 4 and the ring 1 to be large. In this embodiment the first type 6A of latching fingers 6, which have the greatest length, are engaged with the groove 4 and hold the second sleeve 27 against the abutment surface 14. Additionally, the second and third types 6B, 6C of the latching fingers 6 are engaged with the groove 4 and help to hold the second sleeve 27 against the abutment surface 14.

As shown in FIG. 10, the groove 4 is arranged at a second distance d2 from the abutment surface 14. The second distance d2 is greater than the first distance d1 in FIG. 9. As a result, the distance between the groove 4 and the locking ring 1 is smaller than in FIG. 9. In this embodiment the second and third types 6B, 6C of the latching fingers 6 are engaged with the groove 4 and hold the second sleeve 27 against the abutment surface 14.

As shown in FIG. 11, the groove 4 is arranged at a third distance d1 from the abutment surface 14. The third distance d3 is greater than the second distance d2 shown in FIG. 10. As a result, the distance between the groove 4 and the locking ring 1 is small. In this embodiment only the third type 6c of latching fingers 6 engage with the groove 4 to hold the second sleeve 27 against the abutment surface 14.

To attain a locking function with little clearance in the axial direction the first, second, and third types 6a, 6b, 6c of latching fingers 6 should be inclined with the third angle α3, as shown in FIG. 9 for the third type 6C of the latching fingers 6. To further improve the holding function, first, second, and third types 6a, 6b, 6c of latching fingers 6 should be provided at different angles α1, α2, α3, and the angles should increase with the length of the latching fingers 6. Additionally, the different angles α1, α2, α3 reduce the force needed for mating the first and second connector members 2, 3.

The second connector member 3 is held at an axial position in relation to the first connector member 2 so that impedance of the electrical connection between the first and the second connector members 2, 3 is optimal. The axial position of the first connector member 2 relative to the second connector member 3 is important, because the electrical impedance of the connection of the first and second connector members 2,3 depends on their axial position to each other. The first and the second connector members 2, 3 are designed to have the best impedance if the second connector member 3, especially the second sleeve 27 is adjacent to the abutment surface 14 of the first connector member 2.

To unlock the connection between the second connector member 3 and the first connector member 2, the unlocking member 28 is pushed in the direction of the sleeve body 24. By pushing the unlocking member 28 toward the sleeve body 24, a front part of the sleeve body 24 is received in the receiving chamber 40. As a result of this movement, the inner sleeve 30 pushes the latching fingers 6 outwards and out of the annular groove 4 to release the second sleeve 27 for axial movement. The second sleeve 27 can then be drawn out of the sleeve body 24 to disengage the first and second connector members 2, 3.

As shown in FIGS. 9-11, when the latching fingers 6 are provided with different lengths 6A, 6B, 6C, the first and second connector members 2, 3 may be locked in a pre-determined axial position to each other although the body and/or the bore and/or the groove 4 differ from optimal size or position, because the deviation of the optimal size or the optimal position of the groove 4 will be compensated for by the different lengths 6A, 6B, 6C of the latching fingers 6. In a preferred embodiment of the invention the latching fingers 6 with different lengths 6A, 6B, 6C are inclined towards the plane of the locking ring 1 at different angles so that the different lengths 6A, 6B, 6C of the latching fingers 6 can be more effectively lock the body. Additionally, in this embodiment, the latching fingers 6 can lock first and second connector members 2,3 that have a small axial clearance in a large range of distances between the groove 4 and the abutment surface 14 even though the diameter of the second sleeve 27 and/or the diameter of the locking ring 1 vary by a greater range of values.

When the latching fingers 6 of the same length are arranged at opposite sides of the locking ring 1, the body is held against axial movement by the latching fingers 6. Because the second member 3 is thereby always held against the abutment surface 14, the axial position of the first and second connector members 2, 3 is always the same so that the mated connector members 2, 2 exhibit the same electrical properties. This is particularly advantageous in coaxial connectors wherein this position provides preferred electrical properties especially for the behavior of high frequency signals.

I/we claim:

1. An electrical connector, comprising:
a first connector member having a first contact;
a second connector member having a groove and a second contact for electrical connection with the first contact; and
a locking ring disposed on the first connector member, the locking ring having latching fingers that engage the groove when the first connector member and the second connector member are mated to lock the first connector member to the second connector member, the latching fingers being of at least a first type and a second type, the first type having a different length than the second type.

2. The electrical connector according to claim 1, wherein the first type is formed at a different angle with respect to a plane of the locking ring than the second type.

3. The electrical connector according to claim 2, wherein the second type has a shorter length and a smaller angle than the first type.

4. The electrical connector according to claim 3, further comprising a third type of the latching fingers, the third type has a shorter length and a smaller angle than the second type.

5. The electrical connector according to claim 2, wherein the latching fingers extend from an inner side of the locking ring toward a lower side of the plane of the locking ring.

6. The electrical connector according to claim 1, wherein the length of the first type and the length of the second type vary by more than three percent of the length.

7. The electrical connector according to claim 1, wherein the first connector member includes an abutment surface and the latching fingers hold the second connector member against the abutment surface.

8. The electrical connector according to claim 1, further comprising an unlocking member formed to slide adjacent to a surface of the first connector member and formed to engage the latching members to release the latching members from the groove.

9. The electrical connector according to claim 1, wherein the latching fingers are positioned around an annular surface of the locking member, the first type of the latching fingers are arranged directly across from each other on the annular surface and the second type of the latching fingers are arranged directly across from each other on the annular surface.

10. An electrical connector, comprising:
a first connector member having a first contact;
a second connector member having a groove and a second contact for electrical connection with the first contact; and
a locking ring disposed on the first connector member, the locking ring having latching fingers that engage the groove when the first connector member and the second connector member are mated to lock the first connector member to the second connector member, the latching fingers being of at least a first type and a second type, the first type being formed at a different angle with respect to a plane of the locking ring than the second type.

11. The electrical connector according to claim 10, further comprising a third type of the latching fingers, the third type being formed a smaller angle than the second type and the second type being formed at a smaller angle than the first type.

12. The electrical connector according to claim 10, wherein the latching fingers extend from an inner side of the locking ring toward a lower side of the plane of the locking ring.

13. The electrical connector according to claim 10, wherein the first connector member includes an abutment surface and the latching fingers hold the second connector member against the abutment surface.

14. The electrical connector according to claim 10, further comprising an unlocking member formed to slide adjacent to a surface of the first connector member and formed to engage the latching members to release the latching members from the groove.

15. The electrical connector according to claim 10, wherein the latching fingers are positioned around an annular surface of the locking member, the first type of the latching fingers are arranged directly across from each other on the annular surface and the second type of the latching fingers are arranged directly across from each other on the annular surface.

16. An electrical connector, comprising:
a first connector member having a first contact and an abutment surface;
a second connector member having a second contact for electrical connection with the first contact and a groove; and
a locking ring disposed on the first connector member, the locking ring having latching fingers, the latching fingers being of at least a first type and a second type, the first type having a different length than the second type so that the first type engages the groove when the abutment surface is a first distance from the groove and the second type engages the groove when the abutment surface is a second distance from the groove when the first and second connector members are mated to lock the first connector member to the second connector member.

17. The electrical connector according to claim 16, wherein the first type is formed at a different angle with respect to a plane of the locking ring than the second type.

18. The electrical connector according to claim 17, wherein the second type has a shorter length and a smaller angle than the first type.

19. The electrical connector according to claim 18, further comprising a third type of the latching fingers, the third type has a shorter length and a smaller angle than the second type and engages the groove when the abutment surface is a third distance from the groove.

20. The electrical connector according to claim 17, wherein the latching fingers extend from an inner side of the locking ring toward a lower side of the plane of the locking ring.

21. The electrical connector according to claim 16, wherein the length of the first type and the length of the second type vary by more than three percent of the length.

22. The electrical connector according to claim 16, wherein the latching fingers hold the second connector member against the abutment surface.

23. The electrical connector according to claim 16, further comprising an unlocking member formed to slide adjacent to a surface of the first connector member and formed to engage the latching members to release the latching members from the groove.

24. The electrical connector according to claim 16, wherein the latching fingers are positioned around an annular surface of the locking member, the first type of the latching fingers are arranged directly across from each other on the annular surface and the second type of the latching fingers are arranged directly across from each other on the annular surface.
